(19) United States
(12) Patent Application Publication
(10) Pub. No.: US 2019/0341637 A1
(43) Pub. Date: Nov. 7, 2019

(54) PORTABLE ELECTRICITY GENERATION DEVICES AND ASSOCIATED SYSTEMS AND METHODS

(71) Applicant: Massachusetts Institute of Technology, Cambridge, MA (US)

(72) Inventors: Nicholas W. Fine, Manhattan Beach, CA (US); Erik M. Gest, Cambridge, MA (US); Jade A. Hardacker, Edina, MN (US); Camille Henrot, San Francisco, CA (US); Roger D. Lo, San Francisco, CA (US); Jacob Wachlin, Atlanta, GA (US); Yi Zhong, Bellevue, WA (US); Kabir Abiose, Westlake, OH (US); Dakota Freeman, Cambridge, MA (US); Wesley Lau, Cambridge, MA (US); Jared McKeon, Kent, OH (US); Douglas P. Hart, Charlestown, MA (US)

(73) Assignee: Massachusetts Institute of Technology, Cambridge, MA (US)

(21) Appl. No.: 15/971,125

(22) Filed: May 4, 2018

(51) Int. Cl. H01M 8/04082; H01M 8/04089; C01B 3/06; C01B 3/08; H01M 8/065; B01J 7/02

(52) U.S. Cl. CPC H01M 8/04216; H01M 8/04089; C01B 3/065; F16K 15/207; H01M 8/065; B01J 7/02; C01B 3/08

(57) ABSTRACT

Methods and systems for generating electricity from a fuel are generally described. In some embodiments, a first container is used to house a fluid that is capable of reacting to form a fuel, and a second container is used to house a reactant capable of reacting with the fluid to form the fuel. In some embodiments, valves are used to control the flow of fluid between the first container and the second container. In some embodiments, the valve(s) can be configured such that fluid is only transported between the first container and the second container when the pressure within the second container is below a threshold level.

### GOVERNMENT SPONSORSHIP

This invention was made with Government support under Grant No. FA8721-05-C-0002 awarded by the U.S. Air Force. The Government has certain rights in the invention.

### TECHNICAL FIELD

Portable electricity generation devices, and associated systems and methods, are generally described.

### SUMMARY

Methods and systems for generating electricity from a fuel are generally described. In some embodiments, a first container is used to house a fluid that is capable of reacting to form a fuel, and a second container is used to house a reactant capable of reacting with the fluid to form the fuel. In some embodiments, valves are used to control the flow of fluid between the first container and the second container. In some embodiments, the valve(s) can be configured such that fluid is only transported between the first container and the second container when the pressure within the second container is below a threshold level.

The subject matter of the present invention involves, in some cases, interrelated products, alternative solutions to a particular problem, and/or a plurality of different uses of one or more systems and/or articles.

In one aspect, portable systems for producing electricity from a reactant are described. The portable system may comprise a first container comprising an inlet and an outlet as well as a second container comprising an inlet and an outlet. The portable system may also comprise a first valve fluidically connected to the outlet of the first container and the inlet of the second container, the first valve configured to restrict the flow of fluid from the first container to the second container when the pressure within the second container exceeds a threshold value. The portable system, in some embodiments, also comprises a second valve fluidically connected to the inlet of the first container and the outlet of the second container, the second valve configured to allow the flow of fluid from the second container to the first container and to restrict the flow of fluid from the first container to the second container.

In another aspect, methods of generating electricity are provided. The methods may comprise transporting water from a first container, through a first fluidic pathway comprising a first valve, and into a second container such that a reactant within the second container reacts with the water to generate hydrogen gas. In some such embodiments, a first portion of the hydrogen generated within the second container is transported from the second container, through a second fluidic connection comprising a second valve, and to the first container. In some embodiments, a second portion of the hydrogen generated within the second container is transported from the second container to a fuel cell to generate the electricity, and at a point in time after the formation of the hydrogen, the first valve restricts the flow of water from the first container to the second container after the pressure in the second container exceeds a threshold value. In certain embodiments, after the first valve restricts the flow of water from the first container to the second container, the second valve restricts the flow of hydrogen from the second container into the first container.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B are exemplary cross-sectional schematic illustrations of portable systems, according to some embodiments;

FIG. 2 is a schematic illustration of the expansion of a second container of a portable system, according to certain embodiments;

FIG. 3 is an exemplary cross-section schematic of a portion of a portable system, according to some embodiments;

FIG. 4 is an exemplary schematic illustrating the operation of a portable system, according to some embodiments;

FIG. 5 is a cross-sectional illustration of a portable system, according to some embodiments;

FIG. 6 is an exploded illustration of a portable system, according to some embodiments;

FIGS. 7A-7B are cross-sectional and exploded illustrations of exemplary interfaces for containers, inlets, and outlets, according to some embodiments;

FIG. 8 is a chart that shows the power output and pressure vs. time during a test of an exemplary portable system.

### DETAILED DESCRIPTION

Methods and systems for generating electricity from a fuel are generally described. In some embodiments, a first container is used to house a fluid that is capable of reacting to form a fuel, and a second container is used to house a reactant capable of reacting with the fluid to form the fuel. As a non-limiting example, the first container can house water (which is capable of being hydrolyzed to form hydrogen gas), and the second container can house aluminum metal or alloy (which reacts with water to form aluminum hydroxide and hydrogen gas).

In some embodiments, valves are used to control the flow of fluid between the first container and the second container. In some embodiments, the valve(s) can be configured such that fluid is only transported between the first container and the second container when the pressure within the second container is below a threshold level. Arranging the system in this fashion can allow one, in accordance with certain embodiments, to passively control the system such that operational runaway is avoided.

According to certain embodiments, the system can be portable, for example, by employing components with relatively low volumes and/or masses.

The system can also be operated, in accordance with some embodiments, using a variety of reactant sources. For example, when water is employed, the water may originate from any of a variety of suitable water sources. In accordance with certain embodiments, using water as a fuel-generating reactant can enhance the portability of the system, for example, by eliminating the need to carry at least one of the fuel-generating reactants on board.

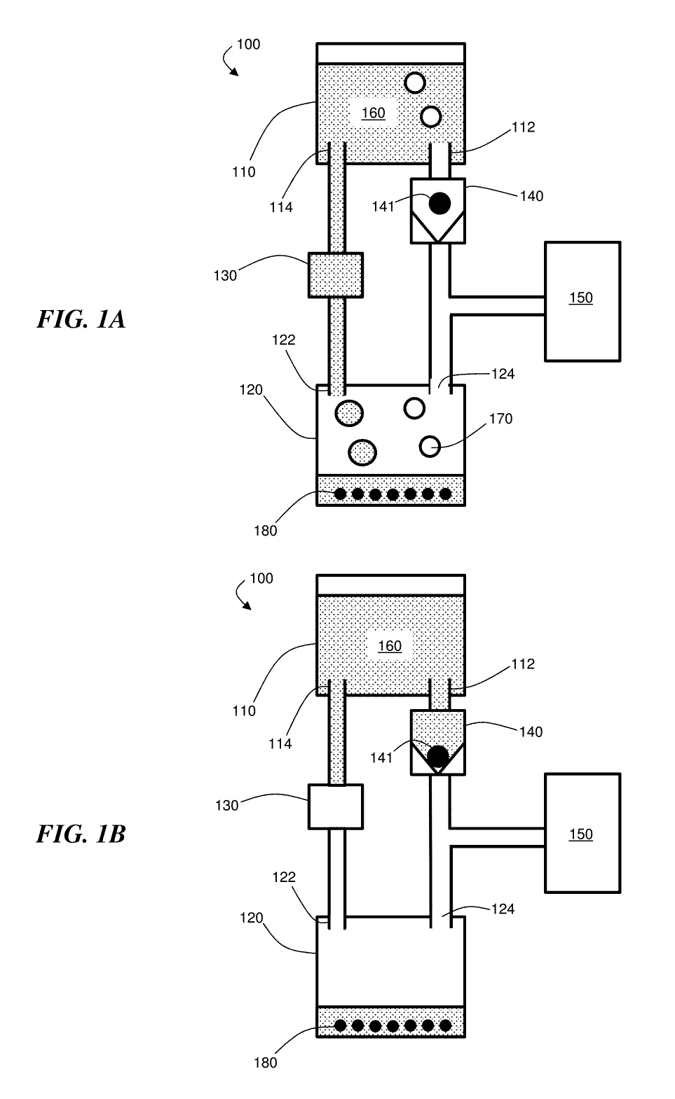

Certain embodiments are related to portable systems for generating electricity from a fuel. FIG. 1A, for example, shows an exemplary schematic of portable system 100.

In certain embodiments, the portable system comprises a first container. For example, in FIG. 1A, portable system 100 comprises first container 110. In some embodiments, the first container comprises an inlet and an outlet. Exemplary inlets and outlets can be seen in FIG. 1A as inlet 112 and outlet 114. The first container may be configured, in accordance with certain embodiments, to contain a fluid such as water. In certain embodiments, the fluid (e.g., water) is used to produce a fuel (e.g., hydrogen) for a fuel cell, as explained in more detail below.

In certain embodiments, the portable system comprises a second container. Exemplary portable system 100, for example, comprises second container 120. The second container, in some embodiments, comprises an inlet and an outlet. For example, second container 120 in FIG. 1A comprises inlet 122 and outlet 124. The second container, may, according to some embodiments, contain a reactant. The reactant in the second container is, in some embodiments, capable of reacting with the fluid from the first container to form a fuel. The fuel, in turn, may be used to generate electricity, as explained in more detail below.

In some embodiments, the portable system comprises a first valve. The first valve, in certain embodiments, is fluidically connected to the outlet of the first container and the inlet of the second container. For example, in FIG. 1A valve 130 of portable system 100 is fluidically connected to outlet 114 of first container 110 and to inlet 122 of second container 120.

In some embodiments, the first valve is configured to restrict the flow of fluid from the first container to the second container when the pressure within the second container exceeds a threshold value. For example, in FIG. 1A, first valve 130 can be configured, in accordance with certain embodiments, such that first valve 130 restricts the flow of fluid 160 from first container 110 to second container 120 when the pressure within second container 120 exceeds a threshold value. Those of ordinary skill in the art would understand that the word “restrict,” as used herein in the context of a valve restricting fluid flow in a particular direction, means that the valve generally does not allow fluid to flow in that direction, although some slight leakage might occur (e.g., due to diffusion, small cracks, etc.). In certain cases, a valve that restricts the flow of fluid in a particular direction does not allow any fluid to flow in that direction. In some cases, a valve that restricts the flow of fluid in a particular direction stops fluid flow in that direction (i.e., the valve operates such that fluid that was previously allowed to flow in that direction is no longer allowed to flow in that direction).

In some embodiments, the portable system comprises a second valve. The second valve, according to some embodiments, is fluidically connected to the inlet of the first container and the outlet of the second container. For example, in FIG. 1A, portable system 100 comprises second valve 140, which is fluidically connected to outlet 124 of second container 120 and to inlet 112 of first container 110.

In some embodiments, the second valve is configured to allow the flow of fluid from the second container to the first container and to restrict the flow of fluid from the first container to the second container. For example, in FIG. 1A, second valve 140 can be configured, in some embodiments, such that second valve 140 allows the flow of fluid 170 from second container 120 to first container 110, and such that second valve 140 restricts the flow of fluid 160 from first container 110 to second container 120. In some embodiments, the system is configured such that, when the pressure within the second container exceeds a threshold value, the second valve also restricts the flow of fluid from the second container to the first container. An example of such operation is described in more detail below with respect to FIG. 1B.

In some embodiments, the first container, first valve, and second container are arranged such that fluid contained in the first container is capable of being transported from the first container to the second container using only force of gravity. For example, first container 110, first valve 130, and second container 120 in FIG. 1A can be arranged, in some embodiments, such that the force of gravity alone causes fluid 160 to flow out of first container 110, through outlet 114, through first valve 130, and into second container 120 via inlet 122.

As mentioned above, the portable system comprises, in some embodiments, a first container. The first container, in accordance with certain embodiments, may be rigid, such as a bottle or canteen made from, for example, a metal or a polymer. In certain embodiments, the first container may be flexible and/or have no defined shape. An example of one such embodiment could be a bag capable of being configured to contain a fluid.

In certain embodiments, the first container is configured to contain a fluid. For example, in FIG. 1A, first container 110 contains fluid 160. In some embodiments, the fluid is a liquid. In some embodiments, the fluid is a gas. In some embodiments, the first container contains water. That is, in certain embodiments, the fluid contained in the first container is or comprises water. In some embodiments, the fluid in the first container is pure or substantially pure (e.g., at least 99 wt %) water. In some embodiments, the fluid in the first container comprises solutes, such as dissolved ions or organic matter. For example, in some embodiments, first container 110 comprises fluid 160, wherein fluid 160 is an aqueous solution. The aqueous solution may be saltwater, urine, and/or wastewater. In some embodiments, the fluid is an aqueous solution with a maximum concentration of dissolved species. In some embodiments, the fluid is an aqueous solution with a concentration of dissolved species of 20 moles per liter (M) or less. In some embodiments, the fluid is an aqueous solution of the concentration the dissolved species of 10 M or less, 5 M or less, 2 M, one mole per liter or less, 1 mM or less, 1 μM or less, or 1 nM or less.

In some embodiments, the fluid contained in the first container comprises water and other liquids. In some embodiments, the fluid comprises water and at least one organic liquid. Organic liquids could include, for example, ethanol, methanol, isopropanol, acetonitrile, acetone, methyl acetate, ethyl acetate, butyl acetate, toluene, benzene, carbonate derivatives, or others. In certain embodiments, the fluid (e.g., the liquid) contained in the first container comprises a minimum percentage of water. In some embodiments, the fluid (e.g., the liquid) is at least 1 wt % water. In some embodiments the fluid (e.g., the liquid) is at least 5 wt %, at least 10 wt %, at least 50 wt %, at least 90 wt %, at least 95 wt %, or at least 99 wt %, or more, water.

As mentioned above, the first container comprises an inlet and an outlet, such as inlet 112 and outlet 114 and first container 110 in FIG. 1A. The outlet may be configured to provide a path for fluid contained in first container to flow out. Similarly, the inlet may be configured to provide a path for fluid to enter the first container. For example, when first container 110 comprises fluid 160, fluid 160 can flow out of first container 110 via outlet 114, while fluid 170 generated in second container 120 can enter first container 110 via inlet 112. In embodiments in which water is reacted with a reactant to generate hydrogen, the outlet may be configured to allow water to exit the first container, and the inlet may be configured to allow a portion of the generated hydrogen to subsequently enter the first container.

In some embodiments, the inlet and/or the outlet are directly attached to the first container.

In some embodiments, the inlet and/or the outlet are indirectly attached to the first container. In one such embodiment, the inlet and/or outlet are fittings incorporated into a screw-on interface attached to the portable system. In some embodiments the inlet and/or outlet are barb fittings. The screw-on interface could then be screwed into the first container, provided that the first container has a corresponding screw interface as well. Such a configuration could allow every-day containers such as water bottles or canteens to be fluidically connected to the portable system merely by screwing them in.

In some embodiments, the first container has a relatively small volume. In some embodiments, the use of a first container having a relatively small volume promotes the overall portability and modularity of the system. It may be advantageous, in some but not necessarily all embodiments, for the first container to have a volume of less than 2500 cm³. In some embodiments, the first container has a volume of less than 1500 cm³. In some embodiments, the first container has a volume of at least 25 cm³. In some embodiments, the first container has a volume of at least 50 cm³, at least 100 cm³, at least 250 cm³, at least 500 cm³, or more. In some embodiments, the first container has a volume of about 1000 cm³. Factors that may affect the chosen volume of the first container include the desired power and/or duration of electricity generation from the portable system.

In some embodiments, the first container is a water bottle or canteen (e.g., any of a variety of commercially available water bottles or canteens). For example, the first container can be, according to certain embodiments, a disposable plastic bottle of water available in grocery or convenient stores. In some embodiments, the first container is a reusable bottle or canteen made from plastics (e.g., polyethylenes, polycarbonates, and/or polyesters). In some embodiments, the first container is a reusable bottle made from a metal (e.g., aluminum, copper, and/or steel). In some embodiments, the first container is made from a flexible or collapsible material. For example, the first container may be a bladder canteen.

In some embodiments, the second container comprises an inlet and an outlet. For example, referring to FIG. 1A, second container 120 comprises inlet 122 and outlet 124. The inlet may be configured to provide a path for fluid that has flowed out of the first container to enter the second container. Similarly, the outlet may be configured to provide a path for fluid to exit the second container. For example, referring to FIG. 1A, when first container 110 comprises fluid 160, and fluid 160 flows out of first container 110, fluid 160 may enter second container 120 via inlet 122. In embodiments in which water is reacted with a reactant to generate hydrogen, the inlet may be configured to allow water to enter the second container, and the outlet may be configured to allow a portion of the generated hydrogen to subsequently exit the second container. In some embodiments, the inlet and/or the outlet are directly attached to the second container.

In some embodiments, the inlet and/or the outlet are indirectly attached to the second container. In one such embodiment, the inlet and/or outlet are fittings incorporated into a screw-on interface attached to the portable system. The screw fitting could then be screwed into the second container, provided that the second container had a corresponding screw interface as well. In some, but not necessarily all, embodiments, it is advantageous for the inlet and/or the outlet to be barb fittings that are incorporated into a screw fitting attached to the portable system. Such a configuration of the inlet and/or outlet could be beneficial in embodiments in which the second container is connected to the fuel cell or first or second valves via tubing. In some such embodiments, the barb fittings penetrate the surface of the sealed second container when it is attached (e.g., screwed into) the portable system. For example, in some embodiments of FIG. 1A, second container 120 is a sealed container whose surface is punctured by inlet 122 and/or outlet 124. This can allow for the flow of fluid into and/or out of second container 120 via inlet 122 and outlet 124 in some such embodiments.

As mentioned above, the second container may contain a reactant. In some embodiments, the reactant reacts with a first fluid (e.g., water) transported from the first container to the second container to produce a second fluid such as a gas (e.g., hydrogen gas). According to certain embodiments, the gas produced between the reaction of the first fluid and the reactant forms a gas capable of generating electricity. The gas may be capable of generating electricity, for example, via a combustion process and/or an electrochemical process. For example, in some cases, the gas is capable of generating electricity within a fuel cell.

In some embodiments, the second container contains a reactant that generates hydrogen when exposed to water. In some embodiments, the gas produced by the reaction of the reactant in the second container and the fluid transported from the first container comprises or is hydrogen gas (H₂). For example, as shown in FIG. 1A, in some embodiments of portable system 100, reactant 180 is capable of reacting with fluid 160 to generate fluid 170, wherein fluid 160 comprises water and fluid 170 is or comprises hydrogen gas. The hydrogen gas is, in some embodiments, used to generate electricity via combustion or an electrochemical process.

In some embodiments, the reactant is a composition that reacts spontaneously (i.e., reacts exergonically at 25° C. and 1 atm) with water to generate hydrogen gas. One example of a suitable composition is one comprising aluminum or alloys/mixtures thereof. An exemplary chemical reaction between aluminum and water is as follows:

2Al+6H₂O→2Al(OH)₃+3H₂

The above reaction is highly exothermic, with a change in enthalpy of approximately −280 kJ/mol_{H2}. In some embodiments, the reactant comprises both aluminum and gallium.

Another exemplary reactant is one comprising magnesium or alloys/mixtures thereof. In some embodiments, magnesium is alloyed or mixed with iron. The reactant may also be a composition comprising a reductant capable of forming hydrogen from water, such as lithium borohydride or other similar compounds. Accordingly, in some embodiments, the reactant comprises aluminum, magnesium, iron, and/or lithium borohydride.

In some embodiments, the reactant is a solid. In certain, but not necessarily all embodiments, it is advantageous for the reactant to be a crushed solid, so that it has a higher surface area and therefore undergoes faster chemical reactions. In some embodiments, at least a portion of reactant is in the form of particles. In some embodiments, at least a portion of the reactant is in the form of substantially spherical particles. In some embodiments, the particles have a largest cross-sectional dimension of up to 10 mm. In some embodiments, the particles have a largest cross-sectional dimension of up to 5 mm, up to 3 mm, up to 1 mm, up to 0.5 mm, or less. In some embodiments, the particles have a largest cross-sectional dimension of at least 10 nm. In some embodiments, the particles have a largest cross-sectional dimension of at least 50 nm, at least 100 nm, at least 500 nm, at least 1 μm, at least 10 μm, at least 0.1 mm or more. As used herein, the “largest cross-sectional dimension” of an article is the largest dimension of the article that extends, in a straight line segment, from one external surface of the article, through the geometric center of the article, and to another external surface of the article.

As one non-limiting example, reactant 180 in FIG. 1A comprises, in some embodiments, crushed aluminum. In some embodiments, reactant 180 in FIG. 1A comprises crushed magnesium mixed with iron particles. In certain embodiments, reactant 180 in FIG. 1A comprises lithium borohydride powder.

In some embodiments, the waste produced from a reaction between reactant in the second container and fluid transported from the first container is recyclable. For example, if the reactant comprises aluminum and the reaction that takes place in the second container is the reaction shown above, then the waste from the reaction would be aluminum hydroxide (Al(OH)₃). Aluminum hydroxide is 100% recyclable, and can either be converted back into aluminum foil if recovered, or sold back into the market as a commercially viable substance.

The second container can be made from any of a variety of suitable materials. In some embodiments, the second container is made of a material that is gas tight with respect to hydrogen. In certain embodiments, the second container is made of a material that is inert toward hydrogen. In some embodiments, the second container is made from a polymeric material. For example, the second container may be made from the heavyweight nylon pack cloth material. A lightweight nylon pack cloth material could also be used. Other suitable polymeric materials for the second container include, but are not limited to, Tedlar® plastic, (polyvinyl fluoride), Mylar, or Cordura® Nylon.

In some embodiments, the second container is sealed from the outside environment. In being sealed from the outside environment, in accordance with certain embodiments, the second container may protect any reactant that it contains from reacting with air, moisture, or other components of the outside atmosphere that could interfere with the composition or chemistry of the reactant. Those of ordinary skill in the art would understand that a container is sealed when the interior of the container is not exposed to the environment outside the container, except via diffusion or other forms of insubstantial leakage. For example, in embodiments in which the second container comprises a reducing reactant like aluminum, the second container being sealed could prevent ambient oxygen from oxidizing the aluminum to Al(OH)₃ and/or Al₂O₃ and consequently poisoning its reactivity. In one non-limiting embodiment of the portable system, the second container is made from a heat sealed heavyweight nylon pack cloth. In some embodiments, the second container is treated with a waterproof coating. In some embodiments, the container is hermetically sealed. In some embodiments, the container has a leak rate, with respect to hydrogen gas (H₂) is less than or equal to 1.0×10⁻³ atm-cc/sec; less than or equal to 1.0×10⁻⁵ atm-cc/sec; less than or equal to 1.0×10⁻⁷ atm-cc/sec; or less than or equal to 1.0×10⁻¹⁰ atm-cc/sec. Those of ordinary skill in the art are familiar with leak rates measured in terms of “atm-cc/second.” A leak rate of 1 atm-cc/second means one cubic centimeter of the gas leaks per second at ambient atmospheric pressure and temperature.

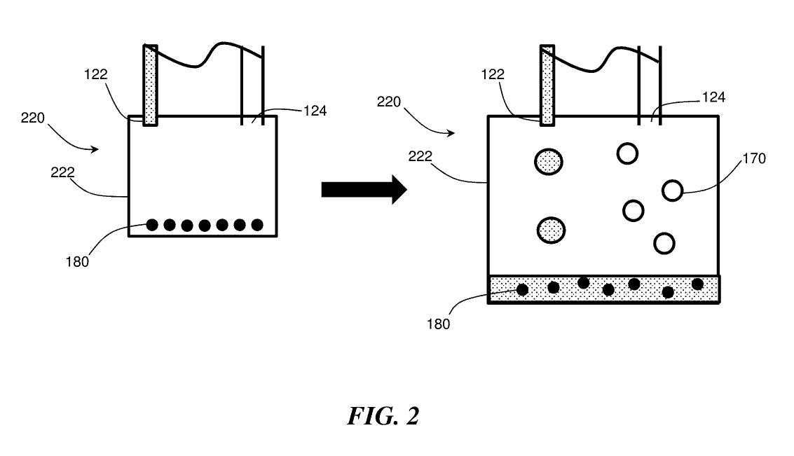

In some embodiments, the second container can be configured to have its volume expand during operation of the portable system. In some embodiments, the second container comprises an expandable wall. Such an embodiment can be achieved in cases where, for example, the expandable wall is elastic. In some embodiments in which the expandable wall is elastic, the second container comprises materials like elastic nylon. In some such embodiments, the volume of the second container depends on the pressure inside the second container relative to the pressure outside the container. The buildup of gas from a reaction between a fluid and the reactant in the portable system may cause the pressure inside the second container to increase. Such an increase in pressure inside the second container may cause the expandable wall of the second container to move in such a way that the volume of the second container increases. In other words, the second container may be inflatable. A schematic of an exemplary embodiment is illustrated in FIG. 2. In FIG. 2, in accordance with certain embodiments, second container 220 comprises expandable wall 222 as well as inlet 122, outlet 124, and reactant 180. In some embodiments, in the absence of fluid like water or hydrogen gas, the pressure within the second container 220 is the same as the pressure outside second container 220, and accordingly second container 220 has a certain volume, as shown on the left of FIG. 2. However, in some embodiments, if fluid 170, which could be a gaseous product such as hydrogen, is formed in second container 220, then the pressure within the second container 220 may become greater than the pressure outside second container 220. Such a pressure difference may, in accordance with certain embodiments, force expandable wall 222 to move in such a way that the volume of second container 220 increases, as shown on the right of FIG. 2.

In some embodiments, the second container has a volume of less than 500 cm³ when the pressure within the second container is the same as the pressure outside the second container. In some embodiments, the second container has a volume of less than 400 cm³, less than 200 cm³, less than 100 cm³, or less when the pressure within the second container is the same as the pressure outside the second container. These ranges of volumes for the second container may ensure that the second container, in its packed state, is small enough to be easily carried, stored, and/or manipulated during remote activities such as hiking. In some embodiments, the second container has a volume of at least 25 cm³, at least 50 cm³, at least 100 cm³, at least 250 cm³, or more when the pressure within the second container is the same as the pressure outside the second container.

In some embodiments, there is a minimum factor by which the volume of the second container is capable of expanding. In some embodiments, the second container is capable of expanding, in volume, by at least a factor of 2. In some embodiments, the volume of second container is capable of expanding by at least a factor of 5, by at least a factor of 10, by at least a factor of 20, or more. In some embodiments, the volume of the second container is capable of expanding by a factor of up to 100. In some embodiments, the volume of the second container is capable of expanding by a factor of up to 75, by a factor of up to 50, or less. It may be beneficial for the second container to have a large expandability factor. The large expandability factor may allow the second container to have a small volume when not in use so as to be easily packed and stored, but have a large volume when in use so as to hold a sufficient volume of gaseous product to charge a battery or device having a large energy density.

It should be understood that the use of an expandable second container is not necessarily required, and in some embodiments, the second container has a fixed volume with respect to the pressure inside the second container. That is, in some embodiments, the second container does not expand appreciably if the pressure inside the second container is increased by the evolution of a gas, for example.

As mentioned above, in some embodiments, the portable system comprises a first valve fluidically connected to the outlet of the first container and the inlet of the second container. The first valve can be configured to restrict the flow of fluid from the first container to the second container, which, in some embodiments, comprises a reactant that is reactive towards the fluid. This restriction may occur, for example, when the pressure within the second container exceeds a threshold value. A pressure-dependent restriction of the flow of fluid from the first container to the second container can, in accordance with certain embodiments, allow for the use of highly energy dense reactants that produce fluidic products like hydrogen gas with such a great exothermicity while reducing (or eliminating) the risk of a runaway reaction. In accordance with some embodiments, the use of a pressure-dependent restriction of the fluid flow from the first container to the second container may allow fuel (e.g., H₂ gas) production to proceed at a controlled rate. Controlling the rate of the reaction could then allow for the rate of hydrogen or other gaseous product generation to be appropriately matched with the rate of consumption of the gaseous product (e.g., via a fuel cell) to generate electricity. The use of a pressure-dependent restriction of the fluid flow from the first container to the second container may also prevent over-pressurization and or bursting of the second container, or other components of the portable system.

In some embodiments, the first valve is a regulator. In some such embodiments, the first valve can be any type of regulator, as long as it can be configured to regulate the flow of fluid off the gauge pressure in either the first or second container (or one of their respective inlets or outlets). As used herein, the gauge pressure in a container in a container or inlet/outlet refers to the absolute pressure in the container or inlet/outlet minus the ambient pressure outside the container or inlet/outlet. In some embodiments, the first valve is a regulator that can be configured to regulate the flow of fluid off the gauge pressure in the second container or its inlet. For example, in FIG. 1A, in accordance with certain embodiments, first valve 130 is a regulator that regulates and/or restricts the flow of fluid 160 from first container 110 to second container 120 based on gauge pressure in inlet 122 of second container 120. In these embodiments, the regulator is not configured to regulate off the relative pressure from the inlet of the second container to the outlet of the first container. For example, in some embodiments, first valve 130 is not configured to restrict or regulate the flow of fluid 160 from first container 110 the second container 120 off a relative pressure difference between outlet 114 and inlet 122.

In some embodiments, the first valve is a regulator that is configured to operate passively. A regulator that operates passively is generally configured such that its operation does not require actuation using an electrical signal or actuation by a person. For example, in some embodiments, first valve 130 in FIG. 1A is a passive regulator that operates without requiring actuation by an electrical signal or actuation by a person. In some embodiments, the first valve is a regulator whose operation is caused only by the action (e.g. movement, force, pressure caused by, etc.) of fluids inside the portable system. For example, in some embodiments, the first valve actuates based on the pressure on the interior of the second container and/or its inlet caused by the formation and buildup of a gaseous product generated by the reaction of fluid transported from the first container to the second container and a reactant in the second container. Such embodiments would be an example of the first valve being configured to operate passively. One example of a configuration in which the first valve is a regulator that is configured to operate passively is one in which the first valve is a piston regulator. In some embodiments, the piston regulator is configured to regulate in the manner described above. Other suitable types of regulators could include any that compares the container pressure to the ambient pressure (i.e. regulates off gauge pressure).

In some embodiments, the first valve restricts the flow of fluid from the first container to the second container when the gauge pressure within either the first or the second container (or one of their respective inlets or outlets) is greater than a threshold pressure. For example, in some embodiments, the first valve restricts the flow of fluid from the first container to the second container when the gauge pressure within the second container or its inlet is greater than a threshold pressure. In some embodiments, the threshold pressure is in the range of 0.25 to 10 atm. In some embodiments, the threshold pressure is in the range of 0.25 to 5 atm, in the range of 0.25 to 2 atm, or in the range of 0.25 to 1.5 atm. In some embodiments, the threshold pressure is configured to be at least 0.4 atm. In some embodiments, the threshold pressure can be configured to be any pressure up to 10 atm or more. In some embodiments, the threshold pressure can be configured to be 0.82 atm. The threshold value above which the first valve is configured to restrict the flow of fluid may depend on the desired rate of electricity generation, the pressure required for stable operation of the fuel cell, and/or the breaking pressure of the second container.

While passive regulators have been primarily described, the invention is not necessarily so limited, and in other embodiments, a regulator that is not a passive regulator could be employed. For example, in some embodiments, the first valve can be a regulator that is configured to operate based on an electrical signal and/or manipulation by a person. (That is to say, the first valve can be an “active” regulator.) In some embodiments, the first valve is a regulator that operates (i.e. restricts or allows fluid flow, opens or closes, etc.) based on an electrical signal. For example, exemplary first valve 130 in FIG. 1A, can, in some embodiments, be configured to regulate the flow of fluid 160 from first container 110 to second container 120 based on an electrical signal. The electrical signal could, for example, actuate the first valve when a pressure sensor reads a pressure within the second container and/or its inlet exceeding a threshold pressure value. In some embodiments, the external input is in the form of human interaction. For example, in some embodiments the first valve operates by mechanical manipulation by a person. An example of mechanical manipulation by a person would be a person manually shutting the valve. In some embodiments, the first valve is configured to operate based on an electrical signal, but not based on human interaction. In some embodiments, the first valve is configured to operate based on human interaction, but not an electrical signal. In some embodiments, the first valve is configured to operate based on both an electrical signal and human interaction.

In some embodiments, the portable system comprises a second valve fluidically connected to the inlet of the first container and the outlet of the second container. The second valve may be configured to allow the flow of fluid from the second container to the first container and to restrict the flow of fluid from the first container to the second container. For example, in some embodiments of portable system 100, second valve 140 is configured to allow the flow of fluid 170 to flow from second container 120, through outlet 124, and into first container 110 via inlet 112 as shown in FIG. 1A. Second valve 140 may also be configured to restrict the flow of fluid 160 from first container 110 through inlet 112 and to the second container 120 via outlet 124. In some embodiments, fluid 160 comprises water and fluid 170 comprises hydrogen gas, such that second valve 140 allows the flow of at least a portion of the hydrogen generated via the reaction of the water with reactant 180 (e.g., aluminum) in second container 120 to flow into first container 110. Such a flow of fluid (e.g., hydrogen gas) from second container 120 into first container 110 could prevent the formation of a vacuum as the amount of fluid 160 (e.g., water) in first container 110 is depleted during operation.

In some embodiments, the second valve is a check valve. Any of a number of type of check valves may be used for the second valve. For example, the second valve may be a ball check valve. An exemplary ball check valve is schematically illustrated in FIG. 1A as second valve 140, with optional ball 141. Other types of suitable check valves could include diaphragm check valves, swing check valves, stop check valves, lift check valves, duckbill valves, or pneumatic non-return valves. In certain embodiments, the second valve operates passively (i.e., the second valve is a “passive” valve). For example, the second valve may operate based only on the action of fluids contained in the portable system. One such embodiment is when the check valve is a ball check valve that blocks the passage of a fluid from the first container (e.g. water) into the second container) due to the pressure of the fluid forcing the ball to close access to a passageway in the check valve. The use of passive valves is not necessarily required, however, and in other embodiments, the second valve is an active valve.

The first and second valves of the portable system can, in some embodiments, be configured such that the action of one of the valves affects the operation of the other of the valves. For example, in some embodiments, the portable system can be configured such that when the first valve restricts (e.g. stops) flow of fluid from the first container to the second container, the second valve restricts flow of fluid from the first container to the second container and flow of fluid from the second container to the first container. This is illustrated schematically in FIG. 1B. In FIG. 1B, first valve 130 has restricted the flow of fluid 160 from first container 110 to the second container 120. This prevents fluid 160 from reacting with reactant 180 in second container 120, thereby preventing the formation of fluid 170 (e.g., hydrogen gas). Without the upward pressure from fluid 170 on second valve 140, ball 141, and inlet 112, ball 141 blocks second valve 140, thereby blocking any of fluid 160 that may flow into a second valve 140 in the absence of the upward pressure.

As described above, in some embodiments, the first and/or second valves are passive valves. The use of passive valves may impart a simplicity in design, manufacture, and/or operation of the portable system that is useful, especially for uses in remote locations in which repairs may be difficult.

The fluidic connections in the portable system can take any number of forms. In some embodiments, at least one fluidic connection is made using liquid- and gas-tight tubing or channels. In some embodiments, the tubing is plastic tubing. In certain embodiments, the tubing is metal tubing. In some embodiments, at least one fluidic connection is made by directly attaching or screwing an inlet or outlet (or a fitting into which an inlet or outlet is incorporated) to a valve using common plumbing interfaces.

In some embodiments the portable system further comprises a fuel cell fluidically connected to the second container. In some such embodiments, a fluidic (e.g., gaseous) fuel product from the reaction of fluid contained originally in the first container with the reactant contained in the second container can flow from the second container to the fuel cell and then power a fuel cell reaction that generates electricity. The electricity generated by the fuel cell can then be used, in accordance with certain embodiments, to charge a battery or directly power a device such as a radio or flashlight. For example, portable system 100 shown in FIG. 1A may be configured such that fluid 160 may flow from first container 110 to second container 120, react with reactant 180, and form gaseous product fluid 170. Fluid 170 may then be able to travel through the fluidic connection between second container 120 and fuel cell 150 to power a fuel cell reaction and generate electricity. More specifically, a portable system in which the first container contains water can be configured to allow the water to react with a reactant such as aluminum in the second container to produce hydrogen gas, which could then power a typical hydrogen fuel cell (the other input being O₂ gas from the outside atmosphere).

Generally, a fuel cell comprises an electrochemical cell the converts chemical energy from a fuel into electricity through at least one electrochemical reaction between the fuel and one or more electrodes. Typically, the electrodes comprise a first electrode, which may be an anode, and a second electrode, which may be a cathode.

In some embodiments, fuel cells also comprise an electrolyte. The electrolyte is a substance positioned between the first and second electrodes through which mobile ions may conduct during operation of the fuel cell in order to balance charge and complete the electrical circuit, as well as deliver necessary reactants to the electrodes. In some embodiments, the electrolyte serves as a barrier to gas diffusion, but permits ion transport. This prevents short-circuiting of the cell, in accordance with certain embodiments. For example, in a hydrogen fuel cell, wherein the fuel is hydrogen gas (H₂) and the species that reacts at the cathode (e.g., an oxidant) is oxygen gas (O₂), the electrolyte may prevent hydrogen gas from traveling to the cathode compartment and reacting with oxygen, and/or prevent oxygen gas and traveling to the anode compartment in reacting with hydrogen. The electrolyte may be a liquid or solid solution comprising ions. The electrolyte solution may be aqueous or nonaqueous. Examples of possible electrolytes may include ion-conductive polymers, alkaline aqueous solutions comprising potassium hydroxide, phosphoric acid solutions, molten carbonates, and/or solid oxides.

In some embodiments, the electrolyte comprises a membrane. In some embodiments, the membrane permits ion transport (including proton transport) but prevents diffusion of gases across the membrane. One particularly common, but non-limiting, example of a membrane used in the fuel cell is a polymer electrolyte membrane (PEM, also known as a proton exchange membrane), such as Nafion, which comprises charged groups such as sulfonate groups. In some embodiments, the electrolyte of a fuel cell, like a hydrogen fuel cell, comprises a hydrated PEM through which protons may diffuse and conduct.

As mentioned above, in some embodiments, the first electrode is an anode. The anode of the fuel cell oxidizes the fuel during operation. For example, when the fuel is hydrogen gas, the anode oxidizes the hydrogen gas. This process produces electrons that are injected into the anode, and protons, which are released into the electrolyte solution. This reaction is represented as follows:

H₂→2H⁺+2e⁻

The anode of the fuel cell may comprise a catalyst that accelerates the rate of the reaction at the anode. In some embodiments, the anode comprises a platinum catalyst.

In some embodiments, the second electrode is a cathode. The cathode of the fuel cell can oxidize a second species (e.g., an oxidant) during operation. For example, when the oxidant is oxygen gas, the cathode reduces the oxygen gas. This process removes electrons from the cathode and produces water as a product when protons are available. This reaction is represented as follows:

O₂+4H⁺+4e⁻→2H₂O

The cathode of the fuel cell may comprise a catalyst that accelerates the rate of the reaction at the cathode. In some embodiments, the cathode comprises a platinum and or nickel catalyst.

When the two half reactions operate simultaneously in the fuel cell, the electrons injected into the anode by the first half reaction can flow to the cathode through an electrical connection between the two electrodes. At the cathode, the electrons can then be used to reduce the oxidant. For the two exemplary half reactions shown above, the overall reaction is:

2H₂+O₂→2H₂O, E°_{cell}=1.23 V

The electrical current (i.e., the electricity) generated by the flow of electrons from the anode to the cathode during operation of the fuel cell can be passed over a load to perform work. The hydrogen fuel cell reaction described above, for example, creates current with an electromotive force of 1.23 V. The generated electricity can be used, for example, to charge a battery.

Fuel cells may be operated at any number of temperature ranges. They are often operated at elevated temperatures in order to increase the rate of the electric chemical reactions. In some, but not necessarily all embodiments of the portable system described herein, it is beneficial to employ a fuel cell capable of operating at temperatures in the range of from 0 to 80 degrees Celsius. In some embodiments, the fuel cell is capable of operating at temperatures in the range of from 0 to 60 degrees Celsius. In some embodiments, the fuel cell operates at a higher temperature than the temperature of the fuel stream that flows into the fuel cell, so as to mitigate condensation in the fuel cell. Examples of fuel cells capable of operating under these conditions include the PEM fuel cells such as the Horizon H-30 30 W fuel cell described below.

In some embodiments the fuel cell has a relatively small volume. By using a fuel cell having a relatively small volume, the overall volume of the system can be kept at a small enough size so as to maintain portability of the system. In some embodiments, the fuel cell has a volume of up to 400 cm³ or more. In some embodiments, the fuel cell has a volume of up to 300 cm³, of up to 200 cm³, of up to 100 cm³ or less. In some embodiments, the fuel cell has a volume of at least 10 cm³, of at least 25 cm³, of at least 50 cm³, or more.

In some embodiments the fuel cell has a certain maximum mass. By limiting the maximum mass of fuel cell, the overall mass of the system can be kept mass so as to maintain a lightweight system suitable for carrying. In some embodiments, the fuel cell has a mass of up to 500 g or more. In some embodiments, the fuel cell has a mass of up to 300 g, of up to 150 g, of up to 100 g, or less. In some embodiments, the fuel cell has a mass of at least 10 g, of at least 25 g, of at least 50 g, or more.

In embodiments in which the portable system comprises a fuel cell, the fluidic connection between the fuel cell and the second container may be achieved in any of the ways described for the other fluidic connections above. In some, but not necessarily all, embodiments, the fluidic connection between the fuel cell and the second container is positioned between the second container and the second valve. In some embodiments, the fluidic connection emanating from the outlet of the second container contains a split, with one branch of the split connecting to the fuel cell and the another branch connecting to the second valve such that the second valve is positioned between the split and the inlet of the first container. An example of such a connection is illustrated in FIG. 1A. FIG. 1A shows the fluidic connection emanating from outlet 124 of second container 120 branching in two directions: one direction connecting to second valve 140, the other direction connecting to fuel cell 150. This example of a fluidic connection between the fuel cell and the second container being positioned between the second container and the second valve allows for a portion of fluid 170 to flow to second valve 140 and a second portion of fluid 170 to flow to fuel cell 150. In this way, fluid 170 (e.g., hydrogen) can both prevent vacuum formation in first container 110, and also provide input for the fuel cell to generate electricity.

In some embodiments, the fuel cell may be capable of producing at least 10 W of power. In some embodiments, the fuel cell may be capable of producing at least 20 W of power, at least 30 W of power, at least 50 W of power, or more. In some embodiments, the fuel cell is capable of producing up to 150 W, or more.

Any of a variety of fuel cells can be used in the systems described herein. Examples of commercially available fuel cells that may be used include, but are not limited to, the Horizon Energy Systems H-30 30 W fuel cell, the Horizon H-20 fuel cell, the Horizon Ultralite fuel cell, or the Ballard FCgen-micro fuel cell.

In some embodiments, the portable system may serve as a small, lightweight energy repository that can serve as a source of electricity. For example, the portable system may be suitable for charging a battery. In some embodiments, the portable system has a high energy density and a small volume. For example, the portable system may have a volume of up to 800 cm³, excluding the volume of the first container. Such a size would make it suitable for usage in emergency situations, such as camping, hiking, or other remote activities removed from the electrical grid. In some embodiments, the portable system has a volume of up to 700 cm³, of up to 500 cm³, or less. In some embodiments, the portable system has a volume of at least 100 cm³. In some embodiments, the portable system has a volume of at least 200 cm³, of at least 300 cm³, or more.

In some embodiments, the portable system has an a relatively high energy density. For example, in some embodiments, portable system is capable of storing at least 300 Wh of energy while having a volume of less than 800 cm³, excluding the first container. Such an embodiment would have an energy density of at least about 0.375 Wh/cm³. In some embodiments, the portable system has an energy density of at least 0.1 Wh/cm³. In some embodiments, the portable system has an energy density of at least 0.2 Wh/cm³, of at least 0.3 Wh/cm³, of at least 0.4 Wh/cm³, of at least 0.5 Wh/cm³, of at least 1 Wh/cm³, of at least 2 Wh/cm³, of at least 5 Wh/cm³, or more. In certain embodiments, the portable system has an energy density of up to 20 Wh/cm³ or more. In certain embodiments, the portable system has an energy density of up to 10 Wh/cm³, or less. All of the energy density ranges cited above exclude the volume of the first container.

The first container and second container of the portable system may be able to be easily removed and replaced, providing a beneficial level of modularity. For example, the first container and/or the second container may be small enough to be easily removed and replaced. In some embodiments the first and/or second container may be able to be detached from the portable system. For example, in portable system 100, first container 110, inlet 112, and outlet 114 may be able to be detached (e.g., by unscrewing) from portable system 100. As another example, in portable system 100, second container 120, inlet 122, and outlet 124 may be able to be detached (e.g., by unscrewing) from portable system 100.

In some embodiments, the portable system comprises an electrical system. The electrical system may be used to control the performance of the fuel cell. In some embodiments, the electrical system comprises an onboard microcontroller. In some embodiments, the onboard microcontroller can configured to control the output voltage from the fuel cell. In some embodiments, the onboard microcontroller is configured to perform Maximum Power Point Tracking. Maximum Power Point Tracking is a method by which the microcontroller empirically finds a voltage at which to run the fuel cell that maximizes the power output of the fuel cell under the particular operating conditions. This can be done by having the microcontroller incrementally vary the voltage at which the fuel cell runs until the voltage is at a setting such that any variation in the voltage (increase or decrease) reduces the power output of the fuel cell. It may be beneficial to control the output voltage from the fuel cell so as to maintain fuel cell performance, effectively charge a battery, and/or ensure battery and user safety.

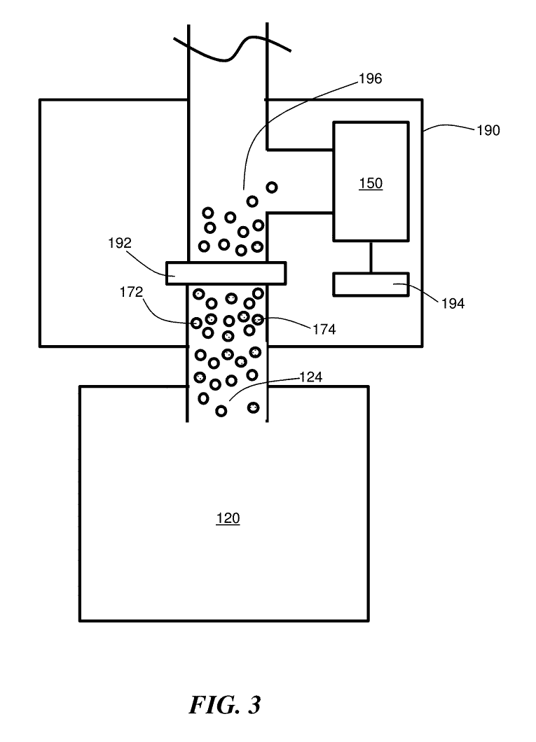

In some, but not necessarily all, embodiments, it is advantageous for the fluidic connection between the second container and the fuel cell to comprise a filter. In some embodiments, the filter is configured to remove residual moisture from the gas stream produced by the reaction between the fluid transported from the first container to the second container and the reactant contained in the second container. For example, referring to FIG. 1A, it may be advantageous to position a filter in the fluidic connection that connects second container 120 to fuel cell 150. This is shown in more detail in FIG. 3. FIG. 3 shows fluidic connection 196 connecting second container 120 to fuel cell 150. Positioned in fluidic connection 196 after outlet 124 and before fuel cell 150 is filter 192. In such a way, when fluid 170 comprises both hydrogen gas 172 and water vapor 174, for example, the filter may remove a portion of the water vapor while allowing the hydrogen gas to continue on to fuel cell 150 as shown in FIG. 3. This filtration may, in some embodiments, improve the performance of the fuel cell and the portable system as a whole.

In some embodiments, the filter is configured such that the amount of water vapor contained in the effluent fluid stream exiting the filter is at least 50 wt % (or at least 75 wt %, at least 90 wt %, at least 95 wt %, or at least 99 wt %) less than the amount of water vapor contained in the fluid stream entering the filter (measured relative to the amount of water vapor contained in the fluid stream entering the filter). For example, when hydrogen gas 172 and water vapor 174 exit second container 120 through outlet 124 and pass through filter 192, filter 192 may absorb water vapor 174 while allowing all hydrogen gas 172 to pass through. If the effluent stream exiting the filter contains 3 wt % water vapor, and the stream entering the filter contains 30 wt % water vapor, then the effluent stream would be said to contain 90 wt % less water vapor than the amount of water vapor contained in the fluid stream entering the filter.

The filter can be any material or device capable of removing water vapor/moisture from a gas stream. In some embodiments the filter comprises a desiccant. Non-limiting examples of such desiccants include activated alumina, aerogel's, calcium chloride, calcium oxide, calcium sulfate, copper (II) sulfate, copper (II) chloride, magnesium sulfate, molecular sieves, potassium carbonate, potassium hydroxide, silica gel, sodium sulfate, and/or sucrose, among others. Upon saturation of the filter, the filter material can be removed and exchanged for fresh desiccant. In certain embodiments, the filter comprises a membrane. The membrane may be hydrophobic. In certain embodiments, the membrane comprises polytetrafluoroethylene (PTFE). A water trap may be used to mitigate water build-up on the filter or saturation of the filter.

In some embodiments the fuel cell, the electrical system, the filter, and, optionally, other components of the portable system may be contained in an enclosure. For example, FIG. 3 shows exemplary enclosure 190, which, in the embodiment shown, contains fluidic connection 196, fuel cell 150, electrical system 194, and filter 192. The enclosure, in some embodiments, may be a rigid casing. In some embodiments, the enclosure comprises screw fittings capable of being attached to the first container and/or the second container of the portable system. It may be beneficial, but not necessary, for the enclosure to be a casing of a hard enough material to protect the components of the portable system contained inside. Suitable materials for the enclosure include, but are not limited to, steel, aluminum, polycarbonate, acrylonitrile butadiene styrene (ABS), or carbon fiber.

In some embodiments, the enclosure contains a majority of the fluidic connections of the portable system. Optionally, the enclosure may comprise both the inlet and outlet of the first container and the inlet and outlet of the second container. The enclosure may also comprise the first valve and/or the second valve.

In some embodiments, the enclosure has a relatively small volume. Using an enclosure having a relatively small volume can, in some embodiments, keep the overall size of the portable system relatively small, thereby imparting a suitable degree portability and ease of packing. In some embodiments, the enclosure has a volume of less than or equal to 300 cm³. In some embodiments, the enclosure has a volume of less than or equal to 200 cm³, less than equal to 100 cm³, or less. In some embodiments, the enclosure has a volume of at least 50 cm³.

Methods of generating electricity using a portable system are also provided. The methods may involve, in accordance with certain embodiments, using any of the portable systems described herein.

In certain embodiments, the method of generating electricity comprises transporting water from a first container, through a first fluidic pathway comprising a first valve, and into a second container such that a reactant within the second container reacts with the water to generate hydrogen gas. For example, one could generate electricity using portable system 100 in FIG. 1A by transporting fluid 160 (e.g., wherein fluid 160 is water) from first container 110, through outlet 114, and through the first fluidic pathway comprising a first valve 130 into the second container 120. When fluid 160 is transported into a second container 120, it may react with reactant 180, wherein reactant 180 is any of the reactants described above (e.g., a reactant comprising aluminum, magnesium, iron, and/or lithium borohydride). For example, water may be transported from first container 110 into second container 120, where it may react with a reactant comprising aluminum to generate hydrogen gas shown as fluid 170 in FIG. 1A.

Moreover, in some methods, a first portion of the hydrogen generated within the second container is transported from the second container, through a second fluidic connection comprising a second valve, and to the first container. For example, in FIG. 1A, a first portion of the generated hydrogen gas may be transported via diffusion out of second container 120 via outlet 124 and into a second fluidic connection that comprises second valve 140 and connects to first container 110 via inlet 112.

In some embodiments, a second portion of the hydrogen generated within the second container is transported from the second container to a fuel cell to generate the electricity. For example, in FIG. 1A, the second portion of the generated hydrogen gas may be transported via diffusion out of the second container 120 via outlet 124, through a fluidic connection, and into fuel cell 150. When the second portion of hydrogen reaches fuel cell 150, it can power a fuel cell reaction, as described above, to generate electricity.

In certain embodiments, at a point in time after the formation of the hydrogen, the first valve restricts the flow of water from the first container to the second container after the pressure in the second container exceeds a threshold value. For example, in FIG. 1A, first valve 130 restricts the flow of fluid 160 (i.e., water) from first container 110 to the second container 120 at a point in time after fluid 170 (i.e., hydrogen gas) is generated and the pressure in the second container exceeds a threshold value.

In some embodiments, after the first valve restricts the flow of water from the first container to the second container, the second valve restricts the flow of hydrogen from the second container into the first container. For example, in some embodiments, after first valve 130 restricts the flow of fluid 160 from first container 110 to second container 120, second valve 140 consequently restricts the flow of hydrogen from second container 120 back into first container 110. This is illustrated in FIG. 1B. FIG. 1B shows the state of the system, in accordance with certain embodiments, at a point during the method in which the generated hydrogen gas has caused the pressure in second container 120 to surpass a certain threshold value with respect to the pressure of the outside environment. In FIG. 1B, first valve 130 has restricted the flow of water from first container 110 to second container 120 and second valve 140 has blocked the flow of hydrogen gas from second container 120 into first container 110.

In some embodiments, the first and/or second valve operate passively. For example, in some embodiments, first valve 130 and/or second valve 140 operate passively (i.e., such that valves 130 and 140 operate without being actuated using an electrical signal and without being actuated by a person). As mentioned above, passive operation can include operation based only on the action of fluids inside the portable system.

In some embodiments, the first valve operates passively by being a regulator (such as a piston regulator) that restricts the flow of fluid when the pressure of the second container exceeds a threshold value, as described above. As mentioned previously, in some embodiments, the regulator acts on the gauge pressure of either the first or second container (or any of their respective inlets or outlets). In some embodiments, the regulator acts on the gauge pressure of the second container or its inlet. In such embodiments, the regulator does not act on the relative pressure difference between the first and second container. The pressure in the second container may exceed that of the outside environment after a buildup of hydrogen gas generated by the reaction of the transported water and the reactant in the second container. In controlling the passage of fluid in this way, in accordance with certain embodiments, the first valve operates passively because its operation is stimulated not by an electrical signal or a manual manipulation of the valve by a user, but by the action of fluids contained in the portable system (e.g. the pressure on the second container and/or its inlet due to hydrogen gas generated by the reaction of water with the reactant in the second container).

In some embodiments, the second valve operates passively by being a check valve that restricts the flow of hydrogen from the second container back to the first container. The second valve may also restrict the flow of water from the first container into the second container via the other fluidic connection in which the second valve resides. In some such embodiments, the second valve's operation is stimulated by the restriction of water flowing through the first valve. When water is restricted from flowing through the first valve, the water naturally will be forced to flow through the second valve. However, in accordance with certain embodiments, because the second valve is a check valve, the water may not pass through it. For example, in FIG. 1B, optional ball 141 prevents water from passing through valve 140. Moreover, in accordance with certain embodiments, when water is restricted from flowing through the first valve, hydrogen generation in the second container ceases, at which point the pressure of hydrogen being transported from the second container into the first container via the second valve is insufficient to pass through the check valve. As in the case of the first valve, in accordance with certain embodiments, the second valve operates passively because its operation is stimulated only the action of fluids contained in the portable system, rather than being stimulated by an electrical signal or manual manipulation of the valve by user.

In some embodiments, the first and/or second valve operate actively (i.e., not passively). One example of a valve operating actively is when the valve is electronically actuated by a signal sent from an electronic pressure sensor based on the pressure reading of that sensor.

In some non-limiting embodiments, the threshold value pressure in the second container above which the first valve restricts water flow falls within a range of 0.25 to 1.5 atm. For example, during the operation of an exemplary portable system shown in FIGS. 1A-1B, in accordance with certain embodiments, when water is first transported from first container 110 to second container 120, the valves operate as shown in FIG. 1A (i.e., first valve 130 allows the flow of water from first container 110 to second container 120, while second valve 140 allows the flow of hydrogen from second container 120 to first container 110). In certain embodiments, as hydrogen gas is generated from the reaction of the water and reactant 180 in second container 120, the pressure inside second container 120 increases from its starting value equal to the outside environment (e.g., an absolute pressure 1 atm if the system is being operated at sea level). In other words, in certain embodiments, the gauge pressure increases from 0.0 atm as hydrogen gas is generated inside second container 120. As the hydrogen gas continues to be generated, in accordance with certain embodiments, once the gauge pressure inside the second container reaches the threshold value pressure, the valves then operate as shown in FIG. 1B (i.e., first valve 130 restricts the flow of water from first container 110 to second container 120, while second valve 140 restricts the flow of hydrogen from second container 120 to first container 110 and restricts the flow of water from first container 110 to second container 120). Later, in accordance with some embodiments, if the hydrogen gas in second container 120 is consumed (e.g., by being transported into fuel cell 150), then the pressure inside the second container 120 will dip back below the threshold value pressure, at which point first valve 130 and second valve 140 will once again allow the flow of fluid. The threshold value pressure may be any of the values provided above (e.g., in the range of between 0.25 to 5 atm, or 0.25 to 2 atm, etc.). In some embodiments, the threshold value pressure is 0.82 atm.

In some embodiments, the water is transported from the first container to the second container using only the force of gravity. For example, in some embodiments using exemplary portable system 100 shown in FIG. 1A, first container 110 comprising water is positioned at a higher height then is second container 120, such that gravity causes water to be transported from first container 110 through the fluidic connection, and into second container 120. In this way, the water is transported passively.

The exemplary methods described herein using passive water transportation and passive operation of the first and/or second valves may be beneficial, in accordance with certain embodiments, because they allow for reduced complexity, easier troubleshooting in remote situations, and a lower balance of system costs.

In certain embodiments, the water is actively transported from the first container to the second container. In some such embodiments, a pump is used to transport the water. The pump could be powered electronically or manually (e.g., a hand-pump).

In some of the methods described above, the first portion of hydrogen, which is generated in the second container, is transported through a first branch of the second fluidic connection and to the first container. For example, in FIG. 1A, a fluidic connection is attached to second container 120 via outlet 124, and then extends upward to a first branch, which extends vertically in the figure toward second valve 140, and a second branch, which extends horizontally in the figure toward fuel cell 150. In some embodiments, a first portion of fluid 170 is transported through the first branch, through second valve 140, and to first container 110.

In some embodiments, the second portion of the hydrogen is transported through a second branch of the second fluidic connection and to the fuel cell. For example, the second portion of fluid 170 in FIG. 1A is, in accordance with certain embodiments, transported through the second, horizontal branch toward fuel cell 150.

By having the second fluidic connection comprise two branches, the hydrogen generated in the second container can be used, in accordance with certain embodiments, to serve two simultaneous purposes: 1) backfilling the first container to avoid vacuum formation (the first portion of hydrogen), and 2) providing an energy-rich reactant to power the fuel cell (the second portion of hydrogen).

In some embodiments, it is beneficial for the method of generating electricity to include expanding the volume of the second container during operation. In such an embodiment, when the hydrogen is generated within the second container, the volume of the second container expands by at least a factor of 2 relative to the volume of the second container prior to the hydrogen generation. As described above, such an expansion can be accomplished, in some embodiments, by using a second container comprising an expandable wall, such as an elastic expandable wall. The pressure generated by the hydrogen generation would then force the expandable wall to move thereby increasing the volume of the second container, in accordance with certain embodiments. For example, in some embodiments, when hydrogen is generated in second container 220 in FIG. 2 (shown on the right), the volume of second container 220 is at least twice as large as the volume of second container 220 when no hydrogen is generated (shown on the left). Expanding the second container during operation may, in some instances, be advantageous because it allows for a large volume of hydrogen to be contained in the second container so as to provide a large amount of electricity, while also allowing the second container to have a smaller volume when not in use. A smaller volume when not in use may allow for easier storage and/or greater convenience during remote activities such as hiking or boating. In some embodiments, when the hydrogen is generated within the second container, the volume of the second container expands by at least a factor of 3, by at least a factor of five, by at least a factor of 10, by at least a factor of 20, or more. In some embodiments, the volume of the second container expands by a factor of up to 50. In some embodiments, the volume of the second container expands by a factor of up to 75, by a factor of up to 100, or more.

As mentioned above, in some embodiments, the second container is, prior to being connected to the system, a sealed, gas tight, inert container that prevents oxidation or other reactivity between the reactant inside and any potentially reactive species in the outside atmosphere. Therefore, in some embodiments, it is beneficial for the method of generating electricity to comprise, prior to the transporting step, exposing the reactant within the second container to the first fluidic pathway. This can be accomplished, for example, by unsealing the second container just prior to connecting the second container to the portable system. This may allow the reactant to be protected during storage but be accessible to water transported from the first container during operation of the portable system. In some embodiments, one way to unseal the second container to expose the reactant to the first fluidic connection is to unscrew a cap that had been tightly screwed on to the second container to expose a threaded opening, which can then be screwed into a corresponding threaded opening located on the portable system. When the second container is screwed into the portable system of such embodiments, the second container is then be fluidically connected inlet and outlets of the second container, thereby exposing the reactant within the second container to the first fluidic pathway. Another possible way to unseal the second container to expose the reactant to the first fluidic connection is to break the seal of the second container. In some embodiments, barb fittings are used for the inlet and outlet of the second container, so that when the second container is attached to the portable system, the inlet and/or outlet pierce the sealed container and allow for exposure of the reactant while keeping the reactant isolated from the outside atmosphere.

Certain embodiments are related to portable power systems that generate electricity from hydrogen generated by the reaction of water and a second reactant. For example, in some embodiments, the portable power system comprises a first container comprising an inlet and an outlet that contains water (e.g., an aqueous solution, pure water, etc.). In some embodiments, the portable power system comprises a second container comprising an inlet and an outlet that contains a second reactant (e.g., an aluminum-containing reactant). In some embodiments, the portable power system further comprises a hydrogen fuel cell. In some embodiments, the portable power system comprises a first valve fluidically connected to the outlet of the first container and the inlet of the second container, the first valve configured to restrict the flow of water from the first container to the second container when the pressure within the second container exceeds a threshold value. In some embodiments, the portable power system comprises a second valve fluidically connected to the inlet of the first container and the outlet of the second container, the second valve configured to allow the flow of hydrogen gas from the second container to the first container and to restrict the flow of water from the first container to the second container.

The following example is intended to illustrate certain embodiments of the present invention, but does not exemplify the full scope of the invention.

### EXAMPLE

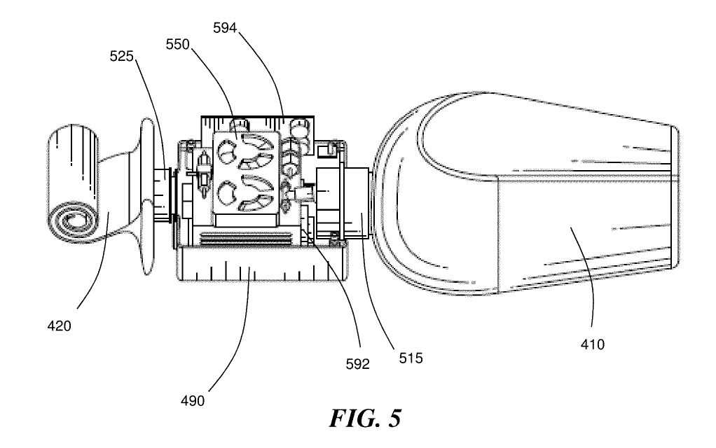

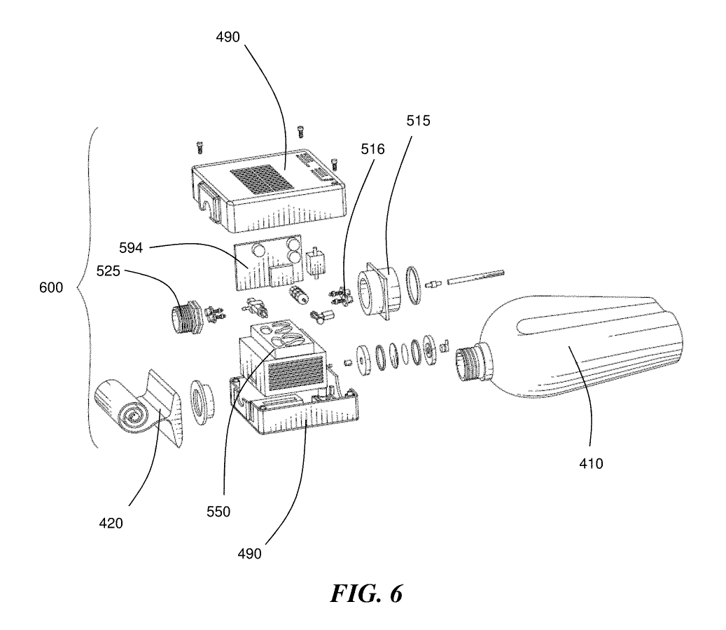

This example describes the assembly and operation of an exemplary portable system. FIG. 5 shows an illustration of an assembled portable system, while FIG. 6 shows an exploded view of the portable system (600). One side of a Qosina T pressure relief valve was attached to the outlet of a Horizon H-30 30 W PEM fuel cell (550 in FIGS. 5-6) equipped with a factory purge valve using 2 mm inner diameter Tygon tubing. The other side of the relief valve was attached to the fuel cell purge valve using additional 2 mm tubing. The fuel cell, fuel cell purge valve, and electrical system (594 in FIGS. 5-6) designed to boost or buck the fuel cell voltage and routinely purge the fuel cell were all electrically connected. The fuel cell inlet and the outlet of a filtration device (592 in FIG. 5) were connected using 1/16″ inner diameter Tygothane tubing. The filtration device comprised barbed inlet and outlet ports and was configured such that all fluid that passed through the device passed through a PTFE membrane. The inlet of the filter was connected to one outlet of a 1/16″ barbed T-fitting using additional 1/16″ tubing. The other outlet of the 1/16″ barbed T-fitting was connected to the input of a Qosina 80129 check valve (with a cracking pressure of 0.05 atm) using additional 1/16″ tubing.

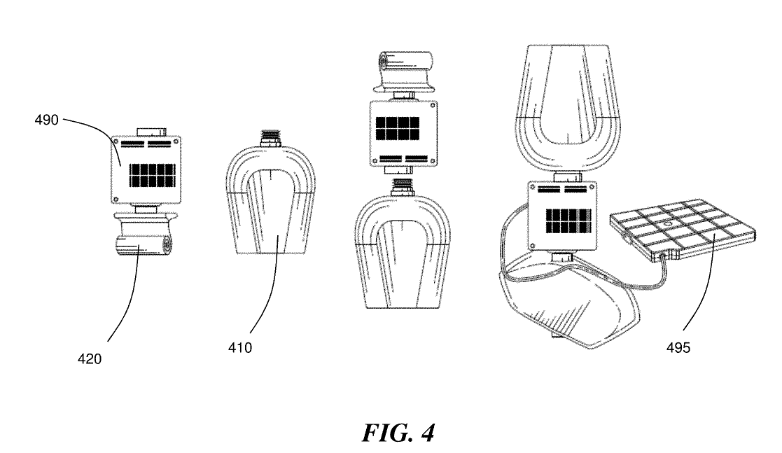

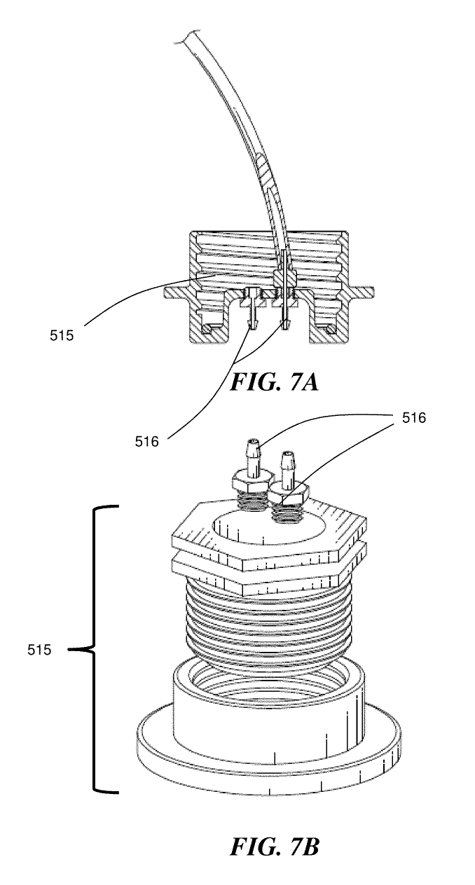

The first container of the portable system was a 1.0 quart military spec plastic canteen (410 in FIGS. 4-6) with a threaded opening. The portable system also included a custom canteen interface (515 in FIGS. 5-7) configured to connect the threaded opening of the canteen to tubing via barbed fittings (516 in FIGS. 6-7), as illustrated in FIG. 7A. The output of the check valve was connected to one of the barbed fittings on the canteen interface using 1/16″ tubing. The other canteen interface barbed fitting was connected to the input of a Beswick PR-MLS pressure regulator using 1/16″ tubing.

The second container of the portable system was an MSR 4L Dromlite bag (420 in FIGS. 4-6) that had a threaded sealable opening. The portable power system also included a custom bag interface (525 in FIGS. 5-6) configured to connect the threaded opening of the Dromlite bag to tubing, also via barbed fittings. The output of the pressure regulator was connected to one of the barbed fittings on the bag interface using 1/16″ tubing. The other barbed fitting of the bag interface was connected to the remaining open outlet of the T-fitting using 1/16″ tubing.

Optionally, all of the abovementioned components, except for the first and second container, were inserted into a 3D-printed ABS enclosure (490 in FIGS. 4-6), such that the threaded sides of both the bag interface and the canteen interface were accessible from the exterior of the enclosure. Additionally, the power outlet of the circuitry was configured to be accessible from outside the case. The enclosure was not used during the experiments described below. When the case was used, the output of the fuel cell purge valve was connected to the exterior of the enclosure using 2 mm tubing.

Crushed 6 mm diameter aluminum BBs that had been treated with gallium were placed in the Dromlite bag, and the bag was then attached to the bag interface.

An illustration of how the portable system was assembled and used is shown in FIG. 4. The portable system with the attached bag containing the aluminum BBs is shown on the left. Next, the canteen was filled with water (second from left), and the portable system was inverted and attached to the canteen via the canteen interface (third image from left). The portable system was then un-inverted such that water was able to flow from the canteen to the bag by the force of gravity, and an electric load (495) was connected to the circuitry output of the portable system (rightmost image in FIG. 4).

During evaluative testing of the pressure regulation of the portable power system, the threshold pressure of the pressure regulator was set to 1.0 atm. When the pressure of the system reached 1.0 atm, the regulator restricted the water flow from the canteen. However, even though the water was cut off, the water and aluminum continued to generate hydrogen and build pressure. This was due to the high flow rate of the water supply from the canteen into the Dromlite bag before the regulator closed. Therefore, the threshold pressure for the pressure regulator was lowered to 0.82 atm, which added enough drag to the system to lower the flow rate.

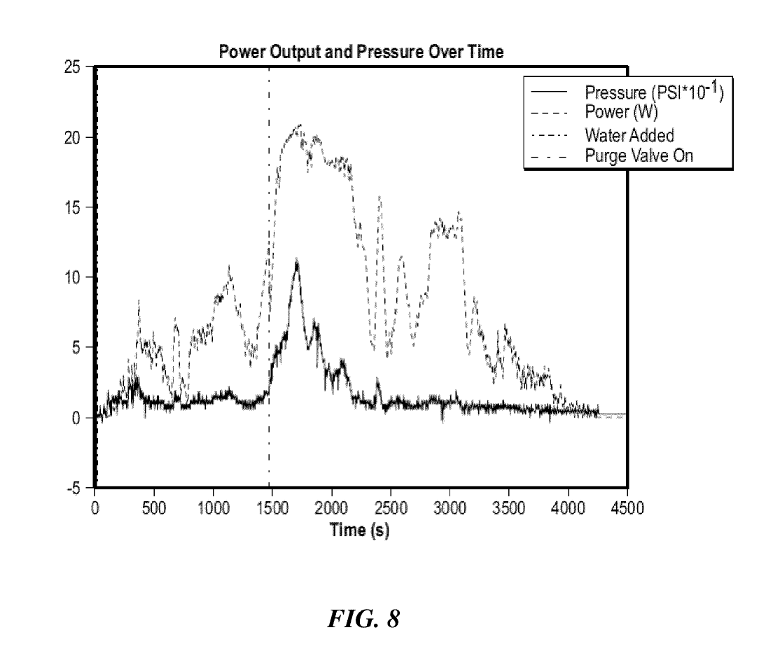

FIG. 8 shows the power output and pressure over time during a test of the portable system. Fifty of the treated crushed aluminum BBs were placed in the Dromlite bag, which was attached to the portable system. A computer was used to measure the pressure of the portable system, with the measurement beginning immediately following the addition of the aluminum. The canteen was then filled with water and connected to the portable system and water flow was begun. The experiment ended when the fuel cell turned off. The purge valve of the fuel cell was initially disconnected, and the water flow began at t=30 seconds. The pressure of the system immediately began to rise following the beginning of the water flow, as seen in the figure. Later, at t=89 seconds the fuel cell lights turned on and the power output reading began to increase as well. At approximately t=330 seconds, the linear rise in pressure of the system leveled off, at which point a steady pressure (and a roughly steady power output) were maintained. This was indicative off the water flow being restricted by the regulator valve at that time, thereby limiting the hydrogen gas generation. The purge valve was placed on at t=325 seconds and removed at 336 seconds. The purge valve was placed on again at t=1475 seconds and stayed for most of the rest of the experiment. The bag was removed at t=2377 seconds and the purge valve was removed at t=3872 seconds. Nearly all the fuel had reacted by the time the fuel cell had turned off.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A portable system for producing electricity from a reactant, comprising:
a first container comprising an inlet and an outlet;
a second container comprising an inlet and an outlet;
a first valve fluidically connected to the outlet of the first container and the inlet of the second container, the first valve configured to restrict the flow of fluid from the first container to the second container when the pressure within the second container exceeds a threshold value;
a second valve fluidically connected to the inlet of the first container and the outlet of the second container, the second valve configured to allow the flow of fluid from the second container to the first container and to restrict the flow of fluid from the first container to the second container.

2. The portable system of claim 1, wherein when the first valve restricts flow of fluid from the first container to the second container, the second valve restricts flow of fluid from the first container to the second container and flow of fluid from the second container to the first container.

3. The portable system of claim 1, wherein the first valve is a regulator.

4. The portable system of claim 1, wherein the second valve is a check valve.

5. The portable system of claim 1, wherein the first container contains water.

6. The portable system of claim 1, wherein the second container contains a reactant that generates hydrogen when exposed to water.

7. The portable system of claim 6, wherein the reactant comprises aluminum, magnesium, iron, and/or lithium borohydride.

8. The portable system of claim 1, wherein the second container comprises an expandable wall.

9. The portable system of claim 8, wherein the expandable wall is elastic.

10. The portable system of claim 1, further comprising a fuel cell fluidically connected to the second container.

11. The portable system of claim 10, wherein a fluidic connection between the fuel cell and the second container is positioned between the second container and the second valve.

12. The portable system of claim 1, wherein the first and/or second valves are passive valves.

13. The portable system of claim 1, wherein the first container has a volume of less than 2500 cm³.

14. The portable system of claim 1, wherein the second container has a volume of less than 500 cm³ when the pressure within the second container is the same as the pressure outside the second container.

15. A method of generating electricity, comprising:
transporting water from a first container, through a first fluidic pathway comprising a first valve, and into a second container such that a reactant within the second container reacts with the water to generate hydrogen gas, wherein:
a first portion of the hydrogen generated within the second container is transported from the second container, through a second fluidic connection comprising a second valve, and to the first container,
a second portion of the hydrogen generated within the second container is transported from the second container to a fuel cell to generate the electricity,
at a point in time after the formation of the hydrogen, the first valve restricts the flow of water from the first container to the second container after the pressure in the second container exceeds a threshold value, and
after the first valve restricts the flow of water from the first container to the second container, the second valve restricts the flow of hydrogen from the second container into the first container.

16. The method of claim 15, wherein:
the first portion of the hydrogen is transported through a first branch of the second fluidic connection and to the first container, and
the second portion of the hydrogen is transported through a second branch of the second fluidic connection and to the fuel cell.

17. The method of claim 15, wherein the reactant with which the water reacts in the second chamber to generate the hydrogen comprises aluminum, magnesium, iron, and/or lithium borohydride.

18. The method of claim 15, wherein the first and/or second valve operate passively.

19. The method of claim 15, wherein, when the hydrogen is generated within the second container, the volume of the second container expands by at least a factor of 2, relative to the volume of the second container prior to the hydrogen generation.

20. The method of claim 15, wherein, prior to the transporting step, the reactant within the second container is exposed to the first fluidic pathway by unsealing the second container.
